(19) United States
(12) Patent Application Publication
(10) Pub. No.: US 2025/0077989 A1
(43) Pub. Date: Mar. 6, 2025

(54) NATURAL LANGUAGE (NL) FOR COMPLEX OPTIMIZATION PROBLEMS IN OPERATIONS RESEARCH (OR)

(71) Applicant: Microsoft Technology Licensing, LLC, Redmond, WA (US)

(72) Inventors: Junxuan LI, Bellevue, WA (US); Arko Provo MUKHERJEE, Issaquah, WA (US); Allison RUTHERFORD, Redmond, WA (US); Sahil BHATNAGAR, Seattle, WA (US); Ryan Patrick WICKMAN, Arlington, TN (US)

(21) Appl. No.: 18/459,222

(22) Filed: Aug. 31, 2023

(51) Int. Cl. G06Q 10/063; G06F 40/40; G06N 3/0455; G06Q 10/04

(52) U.S. Cl. CPC G06Q 10/063; G06F 40/40; G06N 3/0455; G06Q 10/04

(57) ABSTRACT

Example solutions for using natural language (NL) for complex optimization problems in operations research (OR) include: receiving a user input for an OR problem; generating an NL prompt based on at least the user input, the NL prompt comprising an objective, a variable, input data, and a constraint; using a large language model (LLM), generating a domain-specific language (DSL) passage based on at least the NL prompt, the DSL passage representing the OR problem; transpiling the DSL passage into a programming language passage; solving the OR problem, wherein solving the OR problem comprises executing the programming language passage to generate a problem solution; and generating a report of the problem solution.

### BACKGROUND

Operations research (OR) is a discipline that deals with the development and application of analytical methods to improve decision-making, in which mathematical models of real-life scenarios are used to solve problems and analyze what-if scenarios. For example, OR assists in solving in supply chain challenges and allocating constrained resources in order to optimize some objective (e.g., minimizing cost or some time period such as a delay or time to completion, or maximizing some performance metric).

OR may also assist in scheduling resources (e.g., employees, vehicles) where sub-optimal scheduling leads to delays in service for customers. In some industries, the large scale of data takes solutions out of the realm of what is possible to solve by a human, and even coding up a computer-implemented solution may require months to develop and ship. Additionally, the level of mathematical and computer coding skills required to construct OR solutions severely restricts the number of users who are able to avail themselves of the benefits of OR.

### SUMMARY

The disclosed examples are described in detail below with reference to the accompanying drawing figures listed below. The following summary is provided to illustrate some examples disclosed herein.

Example solutions for using natural language (NL) for complex optimization problems in operations research (OR) include: receiving a user input for an OR problem; generating an NL prompt based on at least the user input, the NL prompt comprising an objective, a variable, input data, and a constraint; using a large language model (LLM), generating a domain-specific language (DSL) passage based on at least the NL prompt, the DSL passage representing the OR problem; transpiling the DSL passage into a programming language passage; solving the OR problem, wherein solving the OR problem comprises executing the programming language passage to generate a problem solution; and generating a report of the problem solution.

### BRIEF DESCRIPTION OF THE DRAWINGS

The disclosed examples are described in detail below with reference to the accompanying drawing figures listed below:

FIG. 1 illustrates an example architecture that advantageously uses natural language (NL) for complex optimization problems in operations research (OR);

FIG. 2 illustrates an exemplary workflow, showing various data products and processes, associated with example architecture of FIG. 1;

FIGS. 3A and B illustrate exemplary user input and reports, as may occur when using example architecture of FIG. 1;

FIG. 4 illustrates an exemplary NL prompt, such as may be used in example architecture of FIG. 1;

FIG. 5 illustrates another exemplary NL prompt, such as may be used in example architecture of FIG. 1;

FIG. 6 illustrates an exemplary domain-specific language (DSL) passage, such as may be used in example architecture of FIG. 1;

FIG. 7 illustrates another exemplary DSL passage, such as may be generated in example architecture of FIG. 1;

FIGS. 8 and 9 show flowcharts illustrating exemplary operations that may be performed when using example architectures, such as the architecture of FIG. 1; and

FIG. 10 shows a block diagram of an example computing device suitable for implementing some of the various examples disclosed herein.

Corresponding reference characters indicate corresponding parts throughout the drawings.

### DETAILED DESCRIPTION

Example solutions for using natural language (NL) for complex optimization problems in operations research (OR) include: receiving a user input for an OR problem; generating an NL prompt based on at least the user input, the NL prompt comprising an objective, a variable, input data, and a constraint; using a large language model (LLM), generating a domain-specific language (DSL) passage based on at least the NL prompt, the DSL passage representing the OR problem; transpiling the DSL passage into a programming language passage; solving the OR problem, wherein solving the OR problem comprises executing the programming language passage to generate a problem solution; and generating a report of the problem solution. In some examples, transpiling the DSL passage into the programming language passage requires querying data in a database.

The approach provides significant flexibility, for example in selecting the particular solver to use, from among the users' preferred solver options. Users may observe that some solvers produce superior results or are easier to use in their particular field. As a result, solutions are not tied to any particular OR modeling technique or even a particular OR solver.

Aspects of the disclosure improve the speed of generating OR solutions for real-world problems, such as supply chain problems, and thus provide a practical, useful result to solve a technical problem in the domain of computing. OR solvers increase feasibility checking and optimality solvability for both linear programming (LP) and mixed-integer programming (MIP) problems. An LP problem is the maximization or minimization of a linear function that is subjected to linear constraints. The constraints may be equalities or inequalities. A MIP problem is one in which some of the decision variables are constrained to be integer values (i.e. whole numbers such as −1, 0, 1, 2, etc.) at the optimal solution. The advantages of OR are made available to a larger number of users who may not have high degrees of mathematical and coding skills. This is accomplished, at least in part, by generating an NL prompt based on at least user input, and using a large language model (LLM) to generate a DSL passage based on at least the NL prompt. The DSL passage represents an OR problem.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

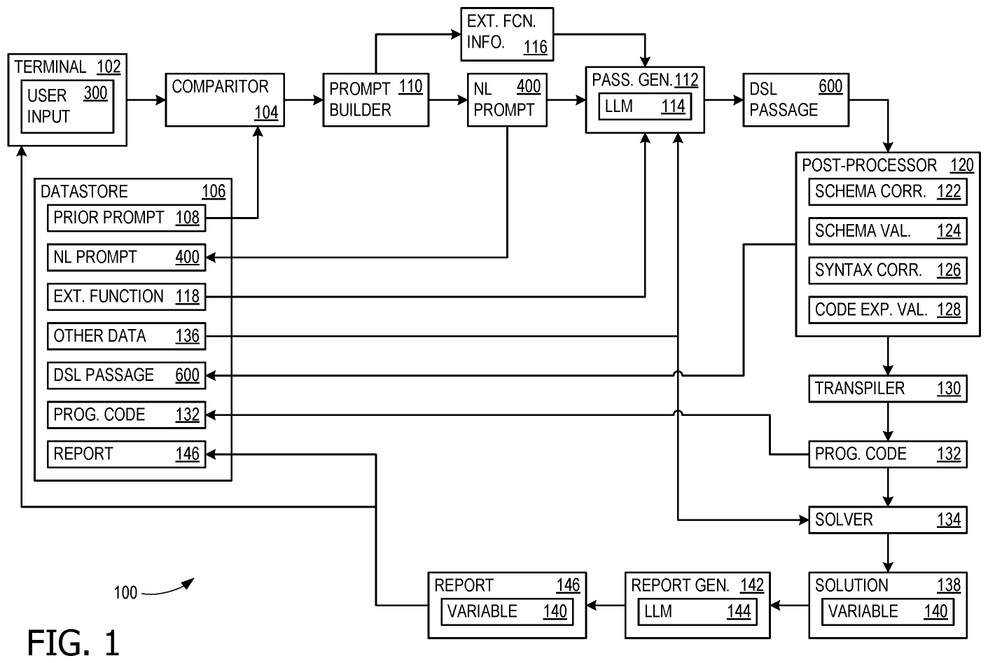

FIG. 1 illustrates an example architecture 100 that advantageously uses NL for complex optimization problems in OR. Architecture 100 provides an end-to-end NL solution, in which both input and output are in NL. This advantageously opens up the wide range of OR benefits to non-technical users, who do not possess the skill to program mathematical models or construct an OR solution.

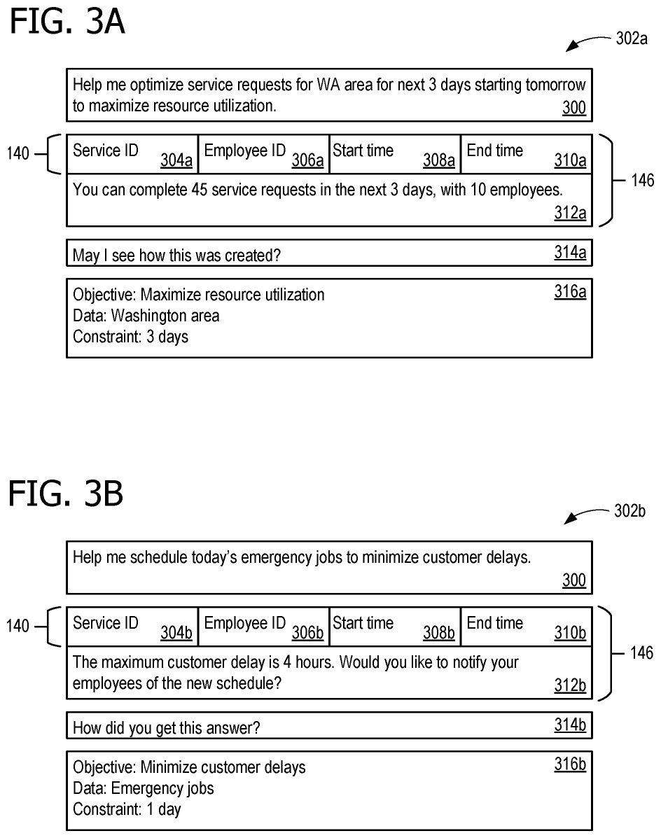

A user at user terminal 102 enters a user input 300 in NL that describes a real-world problem faced by the user (e.g., how to allocate resources in order to optimize some performance metric). Examples of user input 300 are shown in FIG. 3, and a further-detailed description of user input 300 is provided in the description of FIG. 3. A comparitor 104 determines whether user input 300 poses an OR problem that had been encountered earlier, for example be searching within a datastore 106 for a prior-existing NL prompt 108. In some examples, comparitor 104 uses trained machine learning (ML) or artificial intelligence (AI), which is included within ML as used herein. Although datastore 106 is shown as a single storage entity, it represents functionality that may instead be provided by distributed and independent storage solutions.

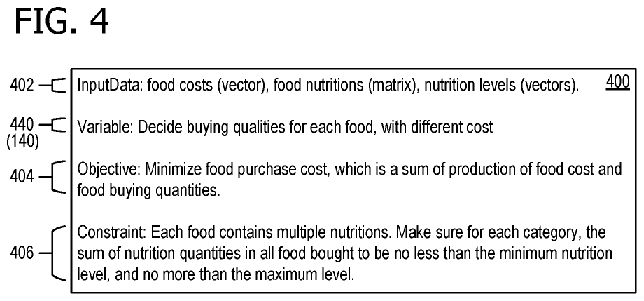

If a relevant prior-existing NL prompt 108 is located, it is provided to a prompt builder 110, and prompt builder 110 generates an NL prompt 400 by modifying prior-existing NL prompt 108 based on at least user input 300. Otherwise, if no prior-existing NL prompt is located, prompt builder 110 generates NL prompt 400 using user input 300. In some examples, prompt builder 110 uses trained ML. Examples of NL prompt 400 are shown in FIG. 4, and a further-detailed description of NL prompt 400 is provided in the description of FIG. 4.

In some scenarios, NL prompt 400 is stored in datastore 106. The next time user input 300 is similar, this NL prompt 400 may be used as prior-existing NL prompt 108.

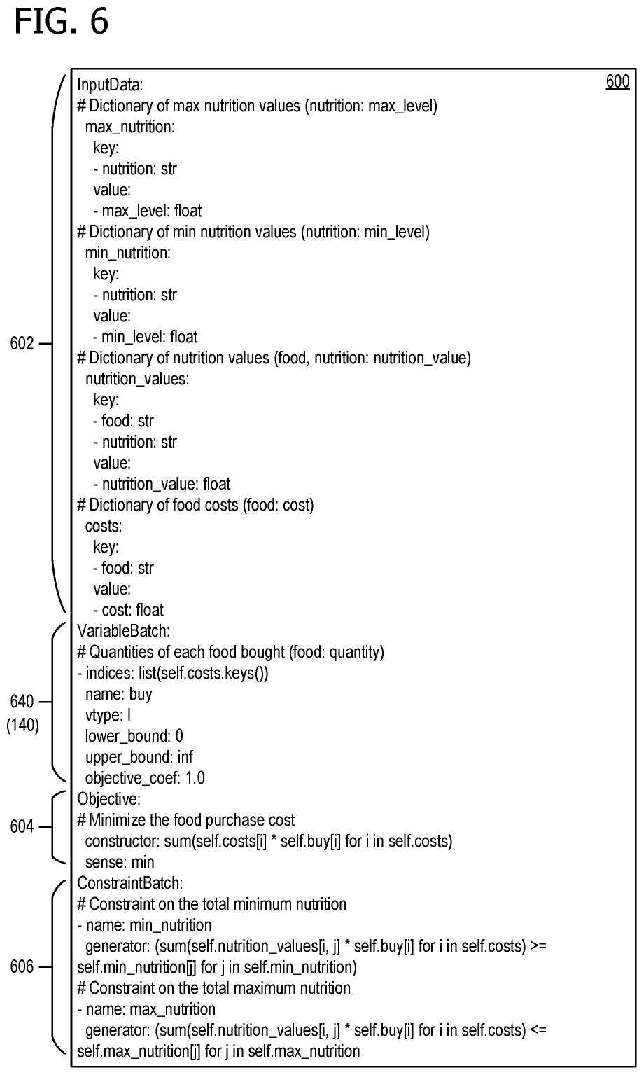

NL prompt 400 is provided to a DSL passage generator 112 that generates a DSL passage 600 using an LLM 114. In some examples, LLM 114 is based on a generative pre-training transformer (GPT) ML model. Examples of DSL passage 600 are shown in FIG. 6, and a further-detailed description of DSL passage 600 is provided in the description of FIG. 6.

In some examples, information 116 regarding an external function 118, which may be relevant to solving the OR problem implicated by user input 300, is provided to DSL passage generator 112. This may be provided by prompt builder 110 or comparitor 104 or another suitable component that parses or processes user input 300 to identify related external functions. If DSL passage generator 112 determines that external function 118 is relevant to solving the OR problem of user input 300, DSL passage generator 112 imports external function 118 into LLM 114 for inclusion in DSL passage 600. In some examples, DSL passage generator 112 references other data 136 in datastore 106, such as calendar data and resource data (e.g., employee databases, maintenance and other schedules, etc.)

A post processor 120, which may use trained ML, provides clean-up of DSL passage 600, including schema correction, schema validation, syntax correction, and code expression validation. A schema correction component 122 provides the schema correction; a schema validation component 124 provides the schema validation; a syntax correction component 126 provides the syntax correction; and a code expression validation component 128 provides the code expression validation. Although separate components are shown, some examples may combine the functionality into a fewer number of components. Any of the components of post processor 120 may use trained ML. The post-processed version of DSL passage 600 may be stored in datastore 106 for future use, or dissemination to other users of examples of architecture 100 that may be faced with similar OR problems.

In various examples, post processor 120 may validate YAML (or other DSL) schema, check for undefined variables, check whether python (or other programming language) expressions are valid, check for duplicate variable definitions, fix malformed attributes (e.g., missing “self”' prefixes), fix duplicate names in constraints (change duplicate “*” names to “*_1” and “*_2”), and check for and rectify hallucinations.

A transpiler 130 transpiles DSL passage 600 into programming language passage 132 (i.e., programming code). Transpiling is the process of taking a code passage written in one language and transforming it into another language that has a similar level of abstraction. In some examples, DSL passage 600 is in YAML, and programming language passage 132 is in python, although other DSLs and programming languages may also be used. In some examples, programming language passage 132 is stored in datastore 106 for future use, or dissemination to other users of examples of architecture 100 that may be faced with similar OR problems.

Programming language passage 132 is executed by a solver 134, which may also use other data 136 in its calculations, to generate a problem solution 138 that contains a value of variable 140. Value of variable 140 provides the answer to a practical question in user input 300, such as an employee schedule (or other resource schedule) or some other answer regarding resources that were the subject of a question in in user input 300. Users may select their preferred solver 134, with one option being a Gurobi Optimizer. In some examples, solver 134 is an interpreter environment that performs line-by-line execution of interpreted code (such as python, R, JavaScript, and Matlab). In some examples, programming language passage 132 is in a compiled language, such as a C-based language, and executing programming language passage 132 comprises compiling programming language passage 132.

A report generator 142 intakes problem solution 138 and produces a more human-readable version as a report 146. In some examples, the purpose of report 146 is to present the value of variable 140 to the user at user terminal 102 in a way that is easily understood by a human. In some examples, report 146 is provided to user terminal 102 and may also be stored in datastore 106. In some examples, however, report 146 (instead or in addition) comprises a database entry, such as in a format for a structured query language (SQL) database. In some examples, report generator 142 uses an LLM 144. LLM 144 may be the same LLL as LLM 114, or may be a different LLM.

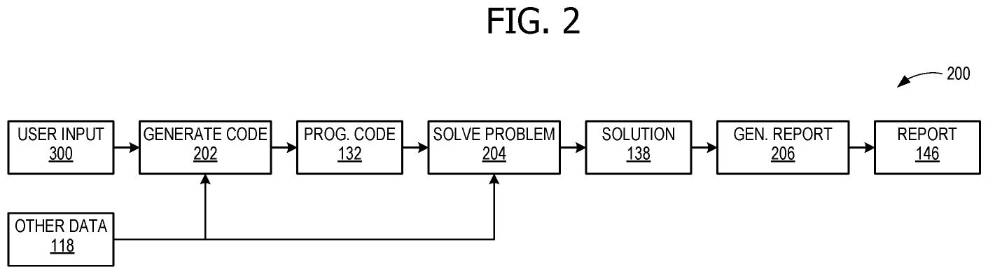

FIG. 2 illustrates an exemplary workflow 200, showing various data products and processes, associated with architecture 100. Workflow 200 provides an “at a glance” visual summary of the functionality of architecture 100.

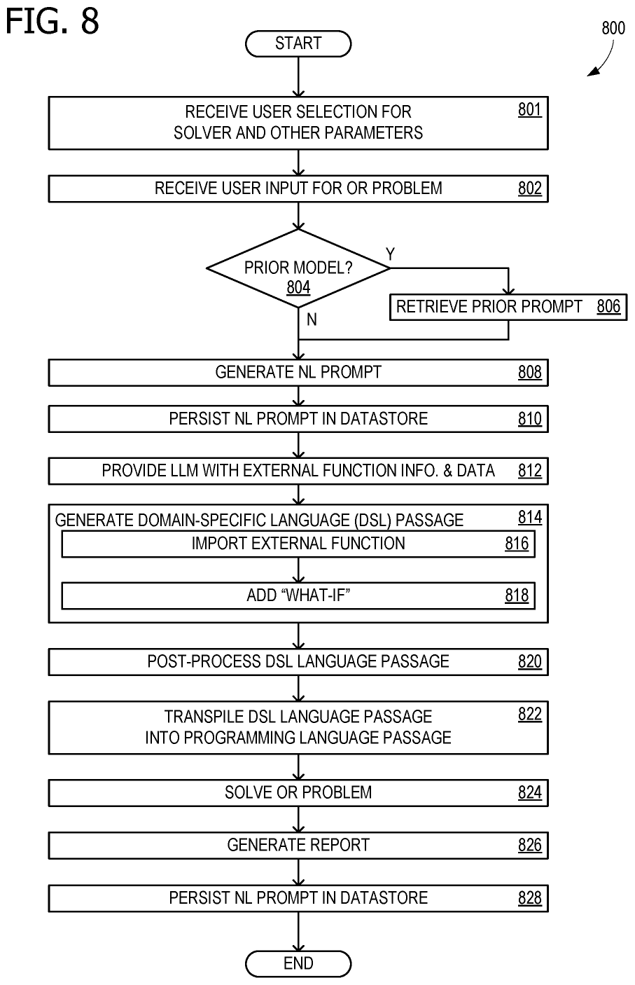

User input 300 and other data 136 are provided to a generate code process 202 that generates NL prompt 400, generates DSL passage 600, and transpiles DSL passage 600 into programming language passage 132. Generate code process 202 corresponds roughly to operations 806, 808, and 812-822 of FIG. 8, described below. A solve problem process 204, which corresponds roughly to operation 824 of FIG. 8, produces problem solution 138. A generate report process 206, which corresponds roughly to operation 828 of FIG. 8, outputs report 146.

FIGS. 3A and B illustrate exemplary user input and reports, as may occur when using architecture 100. FIG. 3A shows a user interface (UI) 302a, presented at user terminal 102, in the form of a chat session. User input 300 requests assistance in optimizing service requests, and indicates a time constraint (“next 3 days, starting tomorrow”) and an objective (“maximize resource utilization). User-provided data (in user input 300) is the Washington state area (“WA area”), although data regarding the current service requests and employee availability, which is necessary to answer the question (i.e., solve the OR problem) will be imported from other data 136. The “WA area” in user input enables identification of relevant other data 136.

Report 146 is provided in part as variable 140, and part as an NL explanation 312a. Variable 140 is a schedule, presented as a table with a column 304a for the service identifiers (IDs) identifying each service order retrieved from other data 136, a column 306a of employee IDs paired with the service IDs, a column 308a of start times, and a column 310a of end times. Start times and end times will presumably be within the constraints of calendar information within other data 136 that shows normal working hours and possibly even employee vacation schedules.

In a further user question window 314a, the user asks for details regarding how variable 140 was calculated. A response window 316a shows an objective, a constraint, and an indication of how relevant other data 136 was selected for problem solution 138.

FIG. 3B similarly shows a UI 302b, presented at user terminal 102, in the form of a chat session. User input 300 requests assistance in scheduling emergency jobs, and indicates a time constraint (“today”) and an objective (“minimize customer delays”). User-provided data (in user input 300) is “today's emergency jobs” that enables identification of relevant other data 136.

Report 146 is provided in part as variable 140, and part as an NL explanation 312b. Variable 140 is a schedule, presented as a table with a column 304b for the service IDs, a column 306b of employee IDs paired with the service IDs, a column 308b of start times, and a column 310b of end times. In a further user question window 314b, the user asks for details regarding how variable 140 was calculated. A response window 316b shows an objective, a constraint, and an indication of how relevant other data 136 was selected for problem solution 138.

Some examples permit more open-ended questions, such as user input 300 of “How many people are needed to fulfill all service requests with electrician skills in the Washington area in the next week?” For such an open-ended OR problem, the objective is defined as a default, such as a minimum count of the resources identified (e.g., “people”).

FIG. 4 illustrates an example of NL prompt 400. NL prompt 400 has input data 402, variable passage 440 that is the form of variable 140, an objective 404, and a constraint 406. Variable 140 may take on different expressions in user input 300, NL prompt 400, DSL passage 600, programming language passage 132, problem solution 138, and report 146. However, some form of variable 140 will carry through from user input 300 to report 146, because it is the critical component in the question to which the user needs an answer. In the answer (report 146) the value of variable 140 optimizes objective 404 subject to constraint 406, using input data 402.

In the example of FIG. 4, input data 402 has specific prompts that food costs and nutrition levels are vectors and food nutritions is a matrix. This is a result of the training of ML functionality within prompt builder 110.

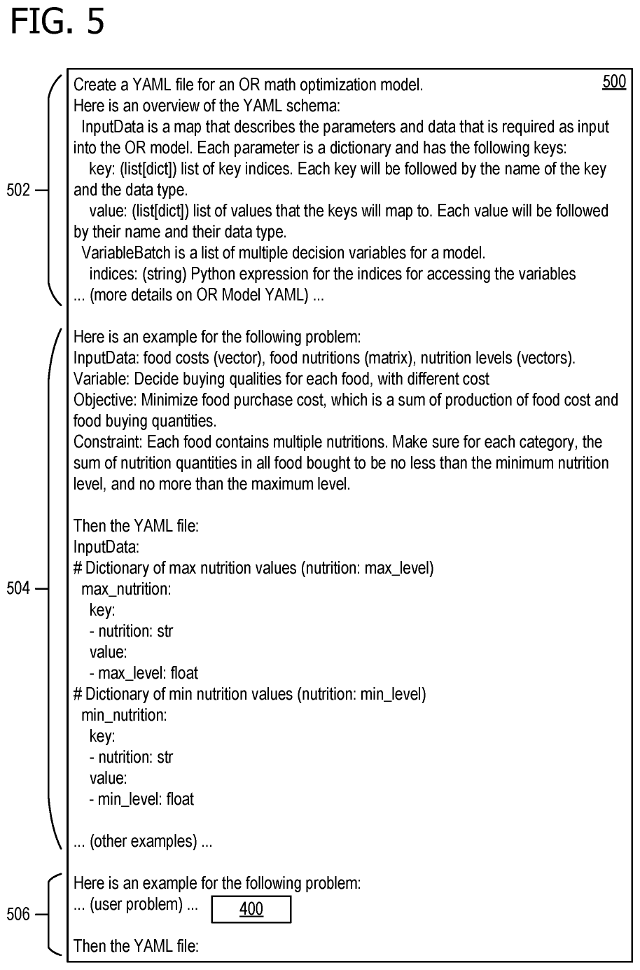

FIG. 5 illustrates another of an NL prompt 500 that includes NL prompt 400 of FIG. 5. In some examples, NL prompt 500 may be used in place of NL prompt 400 within architecture 100. NL prompt 500 has additional features, but includes NL prompt 400, and so is a superset of NL prompt 400. NL prompt 500 includes an instruction 502 to LLM 114 and a few-shot learning example 504.

Instruction 502 instructs LLM 114 to “Create a YAML file for an OR math optimization model” and provides an example YAML schema. In some examples, LLM 114 uses few-shot learning. Few-shot learning is an example of meta-learning, where a learner is trained on several related tasks, during the meta-training phase, so that it can generalize well to unseen (but related) tasks with just a few examples, during the meta-testing phase. NL prompt 400 is included within user prompt section 506.

FIG. 6 illustrates an example of DSL passage 600. DSL passage 600 has an input data passage 602, derived from input data 402 of NL prompt 400; a variable passage 640 that is the form of variable 140 in DSL passage 600, an objective passage 604, derived from objective 404 of NL prompt 400; and a constraint passage 606, derived from constraint 406 of NL prompt 400.

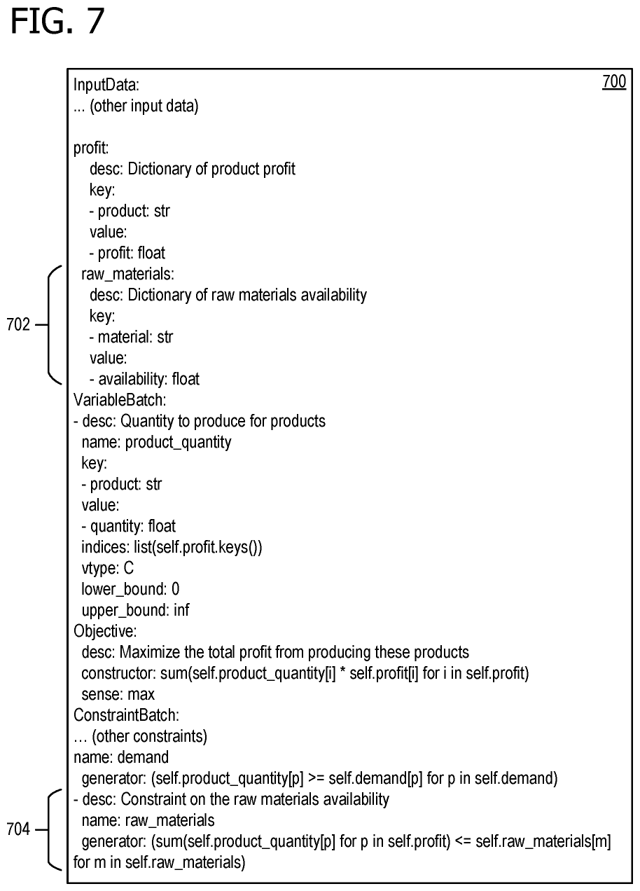

FIG. 7 illustrates an example DSL passage 700 that may be substituted for (used in place of) DSL passage 600 in some examples of architecture 100. DSL passage 700 contains the same elements as DSL passage 600, but additionally addresses a “what-if”' scenario by adding a what-if parameter 702 (“raw materials”) and a what-if constraint 704 in which there is an insufficient amount of what-if parameter 702 to complete the task posed in user input 300. In some examples, DSL passage 600 is edited to add what-if parameter 702 and what-if constraint 704 to convert DSL passage 600 into DSL passage 700.

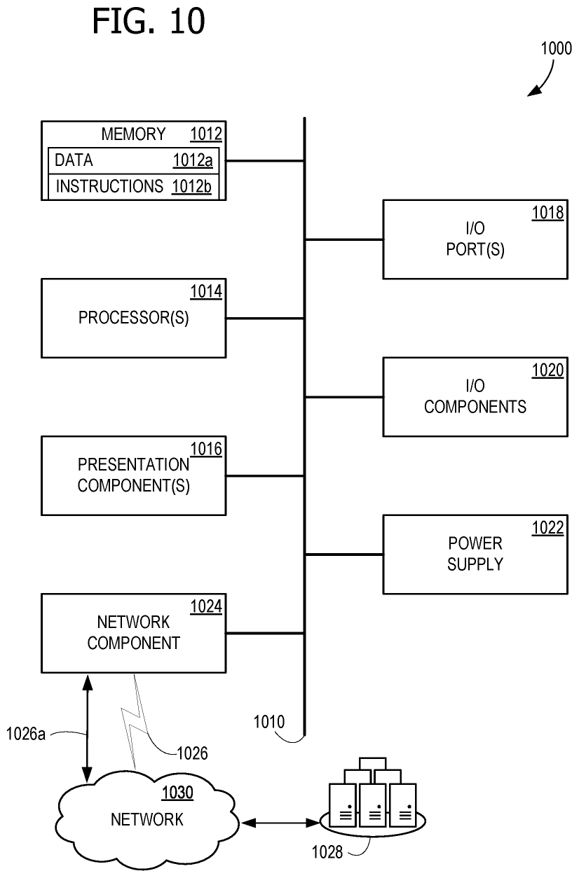

FIG. 8 shows a flowchart 800 illustrating exemplary operations that may be performed by architecture 100. In some examples, operations described for flowchart 800 are performed by computing device 1000 of FIG. 10. Flowchart 800 commences with receiving user selections for solver 134 and other parameters (e.g., the DSL and coding languages to use, in some examples) in operation 801, and also receiving user input 300 for an OR problem in operation 802. User input 300 comprises input data 402 (in some form, although not in exactly the form or as complete as shown in FIG. 4). In some examples, the OR problem comprises a supply chain problem.

Decision operation 804 determines whether the OR problem of user input 300 corresponds to prior-existing NL prompt 108 (using an ML model, in some examples). If so, operation 806 retrieves prior-existing NL prompt 108 (e.g., from datastore 106), based on at least determining that the OR problem corresponds to prior-existing NL prompt 108. Operation 808 generates NL prompt 400 based on at least user input 300. NL prompt 400 represents the OR problem of user input 300 and comprises objective 404, input data 402, and constraint 406. If prior-existing NL prompt 108 is used, generating NL prompt 400 comprises modifying prior-existing NL prompt 108 based on at least user input 300. Some examples generate NL prompt 400 using an ML model. In some examples, NL prompt 400 further comprises instruction 502 to LLM 114 and/or few-shot learning example 504. Operation 810 persists NL prompt 400 in datastore 106.

Operation 812 provides information 116 regarding external function 118 to LLM 114. External function 118 is relevant to the OR problem of user input 300. Operation 814 generates DSL passage 600 based on at least NL prompt 400, using LLM 114, in some examples. In some examples, operation 814 is performed using operations 816 and 818. In operation 816, LLM 114 imports external function 118 and DSL passage 600 is edited to add what-if parameter 702 and/or what-if constraint 704 in operation 818.

Operation 820 performs LLM post-processing on DSL passage 600. The LLM post-processing includes schema correction, schema validation, syntax correction, and/or code expression validation, and may be performed using an ML model. Operation 822 transpiles DSL passage 600 into programming language passage 132.

Operation 824 solves the OR problem of user input 300, as presented within programming language passage 132. This is accomplished by executing programming language passage 132 to generate problem solution 138. Problem solution 138 comprises a value of variable 140 that optimizes objective 404 subject to constraint 406, using input data 402. Operation 826 generates report 146 of problem solution 138, using LLM 144, in some examples. Report 146 comprises an NL passage providing a response to user input 300 and/or a database entry. Operation 828 persists report 146 in datastore 106, possibly along with DSL passage 600 and programming language passage 132.

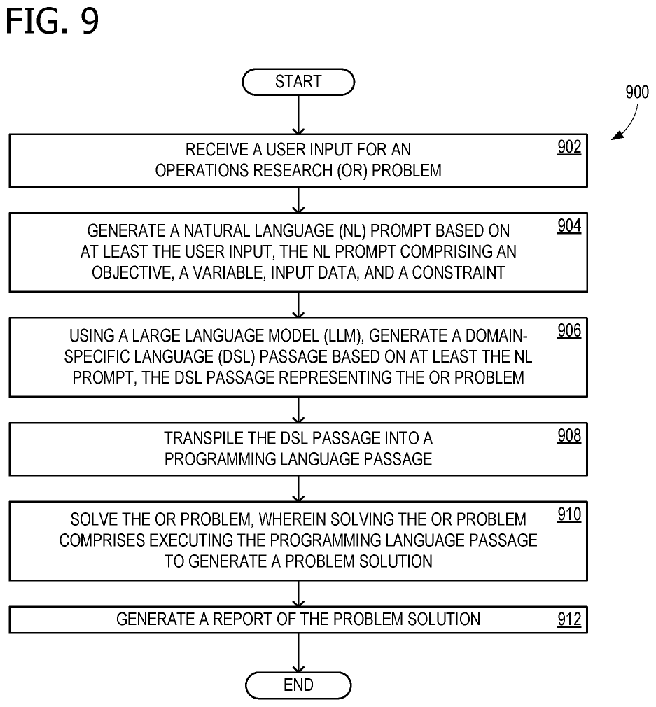

FIG. 9 shows a flowchart 900 illustrating exemplary operations that may be performed by architecture 100. In some examples, operations described for flowchart 900 are performed by computing device 1000 of FIG. 10. Flowchart 900 commences with operation 902, which includes receiving a user input for an OR problem. Operation 904 includes generating an NL prompt based on at least the user input, the NL prompt comprising an objective, a variable, input data, and a constraint.

Operation 906 includes, using an LLM, generating a DSL passage based on at least the NL prompt, the DSL passage representing the OR problem. Operation 908 includes transpiling the DSL passage into a programming language passage. Operation 910 includes solving the OR problem, wherein solving the OR problem comprises executing the programming language passage to generate a problem solution. Operation 912 includes generating a report of the problem solution.

### Additional Examples

An example system comprises: a processor; and a computer-readable medium storing instructions that are operative upon execution by the processor to: receive a user input for an OR problem; generate an NL prompt based on at least the user input, the NL prompt comprising an objective, a variable, input data, and a constraint; using an LLM, generate a DSL passage based on at least the NL prompt, the DSL passage representing the OR problem; transpile the DSL passage into a programming language passage; solve the OR problem, wherein solving the OR problem comprises executing the programming language passage to generate a problem solution; and generate a report of the problem solution.

An example computer-implemented method comprises: receiving a user input for an OR problem, wherein the user input comprises NL; generating an NL prompt based on at least the user input, the NL prompt comprising an objective, a variable, input data, and a constraint; using an LLM, generating a DSL passage based on at least the NL prompt, the DSL passage representing the OR problem; transpiling the DSL passage into a programming language passage; solving the OR problem, wherein solving the OR problem comprises executing the programming language passage to generate a problem solution; and generating a report of the problem solution.

One or more example computer storage devices have computer-executable instructions stored thereon, which, on execution by a computer, cause the computer to perform operations comprising: receiving a user input for an OR problem, wherein the user input comprises NL; using an ML model, generating an NL prompt based on at least the user input, the NL prompt comprising an objective, a variable, input data, and a constraint; using an LLM, generating a DSL passage based on at least the NL prompt, the DSL passage representing the OR problem; transpiling the DSL passage into a programming language passage; solving the OR problem, wherein solving the OR problem comprises executing the programming language passage to generate a problem solution; and generating a report of the problem solution.

Alternatively, or in addition to the other examples described herein, examples include any combination of the following:
determining whether the OR problem corresponds to a prior-existing NL prompt;
based on at least determining that the OR problem corresponds to the prior-existing NL prompt, retrieving the prior-existing NL prompt;
generating the NL prompt comprises modifying the prior-existing NL prompt based on at least the user input;
the NL prompt further comprises an instruction to the LLM and/or a few-shot learning example;
providing to the LLM, information regarding an external function relevant to the OR problem;
generating the DSL passage comprises importing, by the LLM, the external function relevant to the OR problem;
the DSL passage comprises a what-if parameter and/or a what-if constraint;
performing LLM post-processing on the DSL passage;
the LLM post-processing comprises at least one operation selected from the list consisting of: schema correction, schema validation, syntax correction, and code expression validation;
the problem solution comprises a variable value that optimizes the objective subject to the constraint, using the input data;
the report of the problem solution comprises at least one report selected from the list consisting of: an NL passage providing a response to the user input and a database entry;
the user input comprises NL;
the user input comprises the input data;
the OR problem comprises a supply chain problem;
determining whether the OR problem corresponds to the prior-existing NL prompt comprises determining whether the OR problem corresponds to the prior-existing NL prompt using an ML model;
retrieving the prior-existing NL prompt from a datastore;
generating the NL prompt comprises generating the NL prompt using an ML model;
performing LLM post-processing comprises performing LLM post-processing using an ML model;
persisting the NL prompt in the datastore;
the DSL passage comprises a YAML passage;
editing the DSL passage to add the what-if parameter and/or the what-if constraint;
the programming language passage comprises python code;
executing the programming language passage comprises executing the programming language passage in an interpreter environment or compiling the programming language passage;
generating the report using a second LLM; and
the database entry is in a format for a SQL database.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 10 is a block diagram of an example computing device 1000 (e.g., a computer storage device) for implementing aspects disclosed herein, and is designated generally as computing device 1000. In some examples, one or more computing devices 1000 are provided for an on-premises computing solution. In some examples, one or more computing devices 1000 are provided as a cloud computing solution. In some examples, a combination of on-premises and cloud computing solutions are used. Computing device 1000 is but one example of a suitable computing environment and is not intended to suggest any limitation as to the scope of use or functionality of the examples disclosed herein, whether used singly or as part of a larger set.

Neither should computing device 1000 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1000 includes a bus 1010 that directly or indirectly couples the following devices: computer storage memory 1012, one or more processors 1014, one or more presentation components 1016, input/output (I/O) ports 1018, I/O components 1020, a power supply 1022, and a network component 1024. While computing device 1000 is depicted as a seemingly single device, multiple computing devices 1000 may work together and share the depicted device resources. For example, memory 1012 may be distributed across multiple devices, and processor(s) 1014 may be housed with different devices.

Bus 1010 represents what may be one or more buses (such as an address bus, data bus, or a combination thereof). Although the various blocks of FIG. 10 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 10 and the references herein to a “computing device.” Memory 1012 may take the form of the computer storage media referenced below and operatively provide storage of computer-readable instructions, data structures, program modules and other data for the computing device 1000. In some examples, memory 1012 stores one or more of an operating system, a universal application platform, or other program modules and program data. Memory 1012 is thus able to store and access data 1012a and instructions 1012b that are executable by processor 1014 and configured to carry out the various operations disclosed herein. Thus, computing device 1000 comprises a computer storage device having computer-executable instructions 1012b stored thereon.

In some examples, memory 1012 includes computer storage media. Memory 1012 may include any quantity of memory associated with or accessible by the computing device 1000. Memory 1012 may be internal to the computing device 1000 (as shown in FIG. 10), external to the computing device 1000 (not shown), or both (not shown). Additionally, or alternatively, the memory 1012 may be distributed across multiple computing devices 1000, for example, in a virtualized environment in which instruction processing is carried out on multiple computing devices 1000. For the purposes of this disclosure, “computer storage media,” “computer storage memory,” “memory,” and “memory devices” are synonymous terms for the memory 1012, and none of these terms include carrier waves or propagating signaling.

Processor(s) 1014 may include any quantity of processing units that read data from various entities, such as memory 1012 or I/O components 1020. Specifically, processor(s) 1014 are programmed to execute computer-executable instructions for implementing aspects of the disclosure. The instructions may be performed by the processor, by multiple processors within the computing device 1000, or by a processor external to the client computing device 1000. In some examples, the processor(s) 1014 are programmed to execute instructions such as those illustrated in the flow charts discussed below and depicted in the accompanying drawings. Moreover, in some examples, the processor(s) 1014 represents an implementation of analog techniques to perform the operations described herein. For example, the operations may be performed by an analog client computing device 1000 and/or a digital client computing device 1000. Presentation component(s) 1016 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1000, across a wired connection, or in other ways. I/O ports 1018 allow computing device 1000 to be logically coupled to other devices including I/O components 1020, some of which may be built in. Example I/O components 1020 include, for example but without limitation, a microphone, joystick, game pad, satellite dish, scanner, printer, wireless device, etc.

Computing device 1000 may operate in a networked environment via the network component 1024 using logical connections to one or more remote computers. In some examples, the network component 1024 includes a network interface card and/or computer-executable instructions (e.g., a driver) for operating the network interface card. Communication between the computing device 1000 and other devices may occur using any protocol or mechanism over any wired or wireless connection. In some examples, network component 1024 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1024 communicates over wireless communication link 1026 and/or a wired communication link 1026a to a remote resource 1028 (e.g., a cloud resource) across network 1030. Various different examples of communication links 1026 and 1026a include a wireless connection, a wired connection, and/or a dedicated link, and in some examples, at least a portion is routed through the internet.

Although described in connection with an example computing device 1000, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
receive a user input for an operations research (OR) problem;
generate a natural language (NL) prompt based on at least the user input, the NL prompt comprising an objective, a variable, input data, and a constraint;
using a large language model (LLM), generate a domain-specific language (DSL) passage based on at least the NL prompt, the DSL passage representing the OR problem;
transpile the DSL passage into a programming language passage;
solve the OR problem, wherein solving the OR problem comprises executing the programming language passage to generate a problem solution; and
generate a report of the problem solution.

2. The system of claim 1, wherein the instructions are further operative to:
determine whether the OR problem corresponds to a prior-existing NL prompt; and
based on at least determining that the OR problem corresponds to the prior-existing NL prompt, retrieve the prior-existing NL prompt, wherein generating the NL prompt comprises modifying the prior-existing NL prompt based on at least the user input.

3. The system of claim 1, wherein the NL prompt further comprises an instruction to the LLM and/or a few-shot learning example.

4. The system of claim 1, wherein the instructions are further operative to:
provide to the LLM, information regarding an external function relevant to the OR problem, wherein generating the DSL passage comprises importing, by the LLM, the external function relevant to the OR problem.

5. The system of claim 1, wherein the DSL passage comprises a what-if parameter and/or a what-if constraint.

6. The system of claim 1, wherein the instructions are further operative to:
perform LLM post-processing on the DSL passage, the LLM post-processing comprising at least one operation selected from the list consisting of:
schema correction, schema validation, syntax correction, and code expression validation.

7. The system of claim 1,
wherein the problem solution comprises a variable value that optimizes the objective subject to the constraint, using the input data; and
wherein the report of the problem solution comprises at least one report selected from the list consisting of:
an NL passage providing a response to the user input and a database entry.

8. A computer-implemented method comprising:
receiving a user input for an operations research (OR) problem, wherein the user input comprises natural language (NL);
generating an NL prompt based on at least the user input, the NL prompt comprising an objective, a variable, input data, and a constraint;
using a large language model (LLM), generating a domain-specific language (DSL) passage based on at least the NL prompt, the DSL passage representing the OR problem;
transpiling the DSL passage into a programming language passage;
executing the programming language passage to generate a problem solution for the OR problem; and
generating a report of the problem solution.

9. The computer-implemented method of claim 8, further comprising:
determining whether the OR problem corresponds to a prior-existing NL prompt; and
based on at least determining that the OR problem corresponds to the prior-existing NL prompt, retrieving the prior-existing NL prompt, wherein generating the NL prompt comprises modifying the prior-existing NL prompt based on at least the user input.

10. The computer-implemented method of claim 8, wherein the NL prompt further comprises an instruction to the LLM and/or a few-shot learning example.

11. The computer-implemented method of claim 8, further comprising:
providing to the LLM, information regarding an external function relevant to the OR problem, wherein generating the DSL passage comprises importing, by the LLM, the external function relevant to the OR problem.

12. The computer-implemented method of claim 8, wherein the DSL passage comprises a what-if parameter and/or a what-if constraint.

13. The computer-implemented method of claim 8, further comprising:
performing LLM post-processing on the DSL passage, the LLM post-processing comprising at least one operation selected from the list consisting of:
schema correction, schema validation, syntax correction, and code expression validation.

14. The computer-implemented method of claim 8, wherein the problem solution comprises a variable value that optimizes the objective subject to the constraint, using the input data.

15. The computer-implemented method of claim 8, wherein the report of the problem solution comprises at least one report selected from the list consisting of:
an NL passage providing a response to the user input and a database entry.

16. A computer storage device having computer-executable instructions stored thereon, which, on execution by a computer, cause the computer to perform operations comprising:
receiving a user input for an operations research (OR) problem, wherein the user input comprises natural language (NL);
using an ML model, generating an NL prompt based on at least the user input, the NL prompt comprising an objective, a variable, input data, and a constraint;
using a large language model (LLM), generating a domain-specific language (DSL) passage based on at least the NL prompt, the DSL passage representing the OR problem;
transpiling the DSL passage into a programming language passage;
executing the programming language passage to generate a problem solution for the OR problem; and
generating a report of the problem solution.

17. The computer storage device of claim 16, wherein the operations further comprise:
determining whether the OR problem corresponds to a prior-existing NL prompt; and
based on at least determining that the OR problem corresponds to the prior-existing NL prompt, retrieving the prior-existing NL prompt, wherein generating the NL prompt comprises modifying the prior-existing NL prompt based on at least the user input.

18. The computer storage device of claim 16, wherein the operations further comprise:
providing to the LLM, information regarding an external function relevant to the OR problem, wherein generating the DSL passage comprises importing, by the LLM, the external function relevant to the OR problem.

19. The computer storage device of claim 16, wherein the operations further comprise:
performing LLM post-processing on the DSL passage, the LLM post-processing comprising at least one operation selected from the list consisting of:
schema correction, schema validation, syntax correction, and code expression validation.

20. The computer storage device of claim 16,
wherein the problem solution comprises a variable value that optimizes the objective subject to the constraint, using the input data; and
wherein the report of the problem solution comprises at least one report selected from the list consisting of:
an NL passage providing a response to the user input and a database entry.
